(19) United States
(12) Patent Application Publication
(10) Pub. No.: US 2006/0253992 A1
(43) Pub. Date: Nov. 16, 2006

(54) Inflatable pad

(76) Inventor: Paul William Chapman, Bedfordshire (GB)

Correspondence Address: BROWN, RAYSMAN, MILLSTEIN, FELDER & STEINER LLP, 900 THIRD AVENUE, NEW YORK, NY, 10022, US

(21) Appl. No.: 10/559,691

(22) PCT Filed: Jun. 4, 2004
(86) PCT No.: PCT/GB04/02362

§ 371 Date: Apr. 21, 2006

(30) Foreign Application Priority Data
Jun. 6, 2003 (GB) 0313046.5

(51) Int. Cl. A61G 7/057; A47C 27/10

(52) U.S. Cl. 5/713; 5/710

(57) ABSTRACT

A pad (10) of interleaving linear cells (2) has loop straps (1) to hold the central section of the cells (2) linearly in parallel with the cell axis (11), whilst the opposite ends (3) of each cell (2) are secured a pre-determined distance (4) off-set from the cell axis (11). The distance (4) can vary along the length of the pad. By fixing of the ends (3) of the cells (2) at a distance (4) away from the cell axis, each end (3) of the cell (2) is pulled away from the centre axis of the cell, the loop straps (1) and the cell (2) become tensioned, preventing the central cell section from moving or rotating. The resulting cell has been seen to dramatically reduce the movement of a user along the pad with improved user comfort and enhanced pressure relief.

This invention relates to pressure pads, and in particular to alternating pressure pads of the kind used in the prevention and management of decubitous ulcers in bedridden patients.

The formation of decubitous ulcers, commonly known as bed sores, results from, amongst other things, the pressure applied to certain portions of the skin of a bedridden patient. It is known to meet the requirement for the prevention and management of decubitous ulcers with an alternating pressure pad comprising two series of inflatable cells which are interleaved, one series within the other, the cells alternately inflated to support a patient at different locations. Typically, inflation and deflation cycles may last from under two minutes for a gentle massaging effect to over twenty minutes.

Typically, large cells have been used in the form of an elongate cylinder extending linearly straight across a pad. However, these pads have experienced problems in that the alternating inflation and deflation of adjacent cells tends to induce movement of the user down the pad, requiring the user to be manually re-positioned by a nurse or carer. This movement is uncomfortable to the user and areas of the body that require pressure relief from a deflated cell are moved onto an inflated cell resulting in reduced pressure relief for the user.

A further disadvantage encountered with such cells is that a user's bony protuberances, for example, their heels can fall inbetween the inflated cells and rest on the support beneath, therefore experiencing the high pressures likely to cause pressure sores. Furthermore, as the support backrest or pillows are raised to support the user in a seated position, the cells have tended to rotate and separate out under the user's sacrum resulting in the user bottoming and resting on the support beneath the pad.

It is known to have non-linear cells, but there is still some movement of the user down the pad and also rotation of the cells during support of the user in the seated position. Furthermore, the non-linear cells are difficult to manufacture with problems of creases within their inner curvature compromising their pressure relief performance.

The present invention seeks to make improvements.

Accordingly, the present invention provides a pressure pad comprising at least two sets of alternately inflatable cells, the cells extending linearly transversely along the pad and held in place on a pad base by retaining means, characterised in that the retaining means hold the cells in tension across the pad.

By tensioning the cells on the pad, the pad overcomes the problem in prior art alternating linear celled pads, of the cells rotating or moving apart in relation to each other, creating gaps that parts of a user's body could fall through. The tensioned cells also result in reduced movement of the user along the pad thereby increasing user comfort and the pressure relief obtained.

Preferably, the retaining means are releasable. In a preferred embodiment the retaining means secure the opposite ends of each cell at a predetermined distance from the centre linear axis of the cell. More preferably, the retaining means secure the central region of the cells along the centre linear axis of the cell. In the preferred embodiment, the retaining means comprise loop straps fixed to the pad base retaining the central region of each cell and hook type fasteners retaining each opposite end of the cell.

By moving the fixing points of the opposite ends of each cell away from the same centre line as the centre region of the cell held in the loop straps, the loop straps are tensioned. In use, when a user exerts force in lying or sitting upon the cell surface, the cells are not able to move or rotate as with existing prior art pads as the loop straps in their tensioned state have no room to manoeuvre. The resulting cell axis is a curve creating a more stable structure and has been seen to dramatically reduce the movement of a user along the pad with improved user comfort and enhanced pressure relief.

The invention will now be described by way of example only, with reference to the accompanying figures in which:

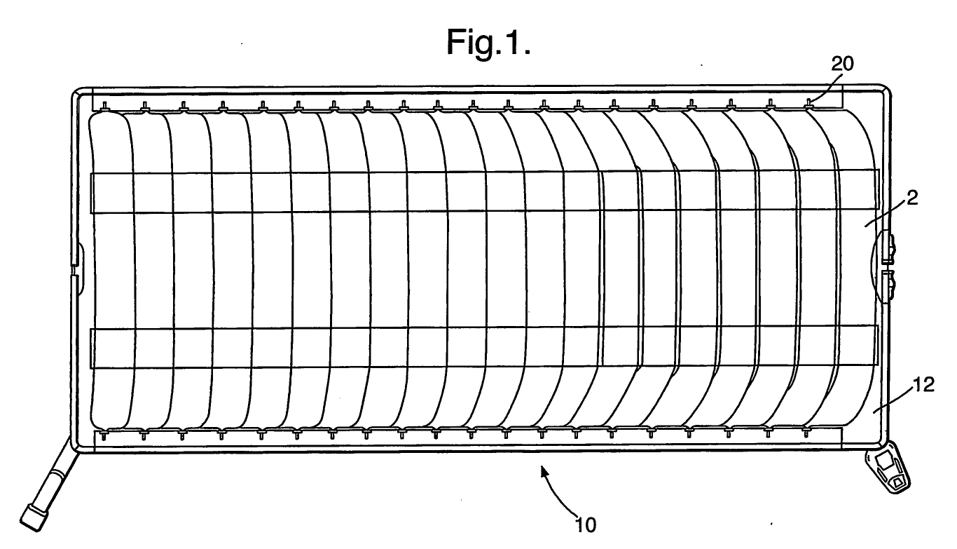

FIG. 1 is a schematic view of a pad according to the invention;

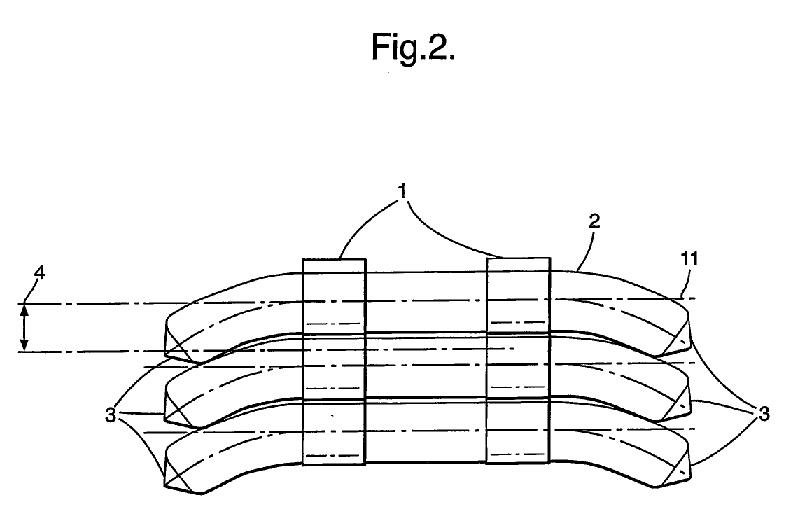

FIG. 2 is a schematic view showing the retaining means of the cells of the pad;

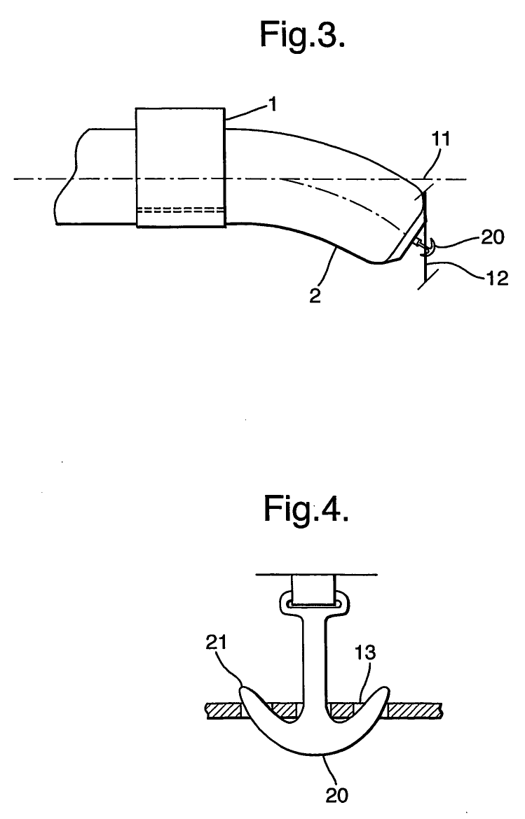

FIG. 3 is a schematic view of the retaining means of a preferred embodiment of the invention; and

FIG. 4 is a plan view of the retaining means in FIG. 3.

FIG. 1 shows a plan view of a pad 10 comprising a bank of interleaving linear cells 2 extending transversely of the pad 10. As shown in FIGS. 1 and 2, loop straps 1 hold the central section of the cells 2 linearly in parallel with the cell axis 11 whereas the opposite ends 3 of the cells 2 are secured a pre-determined distance 4 off-set from the cell axis 11. The distance 4 can vary along the length of the pad.

By fixing of the ends 3 of the cells 2 at a distance 4 away from the cell axis, each end 3 of the cell 2 is pulled away from the centre axis of the cell, the loop straps 1 holding the central section of the cell become tensioned, preventing the central cell section from moving or rotating.

The fact that there is no rotation of the cells is a major advantage because one of the main reasons for the prior art alternating pads inducing downward movement of the user as the cells alternately inflate and deflate, is that with the cell ends anchored on a common linear axis with the loop straps, the loop straps are allowed to pivot about their anchor points and the cells to rotate under a user supported thereupon. These actions act in a similar manner to a conveyor belt. The rising cell supports the user, moves or rotates down the bed, deflates, rises again in its original position and the process continues over and over again.

Moreover, in these prior art alternating pads when a user is positioned in the seated position, a gravitational load is applied to the cells as gravity urges the user down the pad. The resultant movement is uncomfortable to the user and areas of the body that require pressure relief are moved from the deflated cell providing the pressure relief onto an inflated cell with increased contact pressure and resultant compromise in pressure relief.

In a preferred embodiment, each cell end 3 is fitted with a anchor shaped hook 20 which is inserted into a corresponding slot on the pad base 12. (See FIGS. 3 and 4.) The anchor hook 20 is rotated by 90 degrees to align the hook ends 21 with mating apertures 13 within the base 12. The hook ends 21 enter the apertures 13 and secure the cell end 3 to the pad base 12. The cells can be detached from the base 12 by reversing the above procedure.

Although the preferred embodiment describes an anchor shaped hook means for securing the cells to the pad base, other retaining means can be used. For example, press stud fasteners, turn fasteners or similar releasable fasteners can be used to secure the cells in tension in the manner described above.

1. A pressure pad comprising at least two sets of alternately inflatable cells, the cells extending linearly transversely along the pad and held in place on a pad base by retaining means, characterized in that the retaining means hold the cells in tension across the pad.

2. An alternating pad as claimed in claim 1 characterised in that the retaining means are releasable.

3. An alternating pad as claimed in claim 1 characterised in that the retaining means secure the opposite ends of each cell at a predetermined distance from the centre linear axis of the cell.

4. An alternating pad as claimed in claim 3 characterised in that the retaining means also secures the central region of the cells along the centre linear axis of the cell.

5. An alternating pad as claimed in claim 4 characterised in that the retaining means comprise loop straps fixed to the pad base retaining the central region of each cell and hook type fasteners releasably retaining each end of the cell.

6. An alternating pad as claimed in claim 2 characterised in that the retaining means secure the opposite ends of each cell at a predetermined distance from the centre linear axis of the cell.

7. An alternating pad as claimed in claim 6 characterised in that the retaining means also secures the central region of the cells along the centre linear axis of the cell.

8. An alternating pad as claimed in claim 7 characterised in that the retaining means comprise loop straps fixed to the pad base retaining the central region of each cell and hook type fasteners releasably retaining each end of the cell.
